(19) United States
(12) Patent Application Publication
(10) Pub. No.: US 2025/0158159 A1
(43) Pub. Date: May 15, 2025

(54) BATTERY SYSTEM FOR VEHICLES

(71) Applicants: Hyundai Motor Company, Seoul (KR); Kia Corporation, Seoul (KR)

(72) Inventors: Gyung Hoon Shin, Seoul (KR); Jong Gyu Park, Hwaseong-si (KR); Gun Woo Ko, Seongnam-si (KR); Chan Sol Kim, Seoul (KR)

(21) Appl. No.: 18/610,531

(22) Filed: Mar. 20, 2024

(30) Foreign Application Priority Data
Nov. 10, 2023 (KR) 10-2023-0155451

(51) Int. Cl. H01M 10/6556; B60L 50/60; B60R 16/03; H01M 10/613; H01M 10/625; H01M 10/656

(52) U.S. Cl. CPC H01M 10/6556; B60R 16/03; H01M 10/613; H01M 10/625; H01M 10/656; B60L 50/60; H01M 2220/20

(57) ABSTRACT

An embodiment battery system includes a cooling block disposed under a battery pack and a cooling passage that defines a path through which coolant flows by connecting a first passage in the cooling block to second passages in first members disposed on left and right sides of the battery pack and a third passage in a second member disposed at a middle of the battery pack.

### CROSS-REFERENCE TO RELATED APPLICATIONS

This application claims the benefit of Korean Patent Application No. 10-2023-0155451, filed on Nov. 10, 2023, which application is hereby incorporated herein by reference.

### TECHNICAL FIELD

The present invention relates to a battery system for vehicles.

### BACKGROUND

In the case of existing battery packs, several transverse members and longitudinal members are disposed to separate a space where a battery module is mounted.

Accordingly, through-mountings penetrating from an upper case to a lower case of a battery are provided along the transverse members and the longitudinal members, in addition to side members provided at the outer edges, to be engaged at many locations.

Accordingly, as the battery is mounted on a vehicle through a plurality of through-mountings, collision/durability/NVH rigidity between the vehicle and the battery is secured.

Meanwhile, in the case of an electric vehicle battery system, the weight of the electric vehicle should be minimized in consideration of vehicle AER marketability, and it is essential to reduce the weight of the battery system, which occupies a large portion.

To this end, the weight, energy density, and degree of integration (cell ratio within the system) of the battery system should be maximized, and this requires reducing the weight of members and the through-mountings.

However, when the number of members and through-mountings is reduced, the connection structure between the central part and the upper case of the battery system is insufficient, and there is limitation in securing the structural robustness of the battery system.

In addition, in the case of a cooling block constructed by fixing the upper and lower plates with a press, it is disadvantageous from the aspect of structural robustness.

Accordingly, required is the structure of a vehicle body which can secure sufficient cooling performance, while reducing the number of through-mountings and satisfying structural robustness.

The matters described above as the background technology are only to improve understanding of the background of the present invention, and they should not be taken as an acknowledgment that the matters correspond to the prior art known to the public.

### SUMMARY

The present invention relates to a battery system for vehicles. Particular embodiments relate to a battery system for vehicles, which can secure structural robustness of a battery system while enhancing cooling performance by improving the structure of a cooling passage.

Embodiments of the present invention can solve problems in the art and provide a battery system for vehicles, which can secure structural robustness of a battery system while enhancing cooling performance by improving the structure of a cooling passage.

A configuration of an embodiment of the present invention includes a battery system for vehicles comprising a cooling block provided under a battery pack and a cooling passage that forms a path through which coolant flows by connecting a passage in the cooling block to passages in members disposed on the left and right sides of the battery pack and a passage in a member disposed in the middle of the battery pack.

A longitudinal member is disposed in the longitudinal direction in the middle of the battery pack, a passage is formed along the longitudinal member, and the passage of the longitudinal member is connected to the passage formed inside the cooling block, thus the coolant in the cooling block may flow into the passage of the longitudinal member.

The cooling passage may include a first passage formed in the longitudinal direction along the side members provided on the left and right sides of the battery pack, a second passage formed in the traverse direction inside the cooling block to be connected to the first passage, and a third passage formed in the longitudinal direction along a longitudinal member provided in the middle of the battery pack to be connected to the second passage.

As the third passages connected to the second passages on the left and right sides are separately formed, the coolant may be independently discharged through each of the third passages.

An inlet through which the coolant flows in may be provided at an end of the first passage, and an outlet through which the coolant is discharged may be provided at an end of the third passage.

An insertion groove may be formed between the left and right cooling blocks, the longitudinal member may be assembled in the insertion groove, and the passages formed in the left and right cooling blocks and the passages formed inside the longitudinal member may be open to each other while the longitudinal member and the left and right cooling blocks are in surface contact so that the passages of the cooling blocks and the passages of the longitudinal member are connected to each other.

A partitioning unit may be formed to protrude on the bottom of the longitudinal member and is assembled in the insertion groove, the passages of the longitudinal member may be formed on the left and right sides of the partitioning unit in a shape having an open bottom, and the passages of the left and right cooling blocks may be formed in a shape having an open top to be connected to the open passages of the longitudinal member.

A lower end of the longitudinal member may be assembled in the insertion groove, the passages of the longitudinal member may be formed in a shape having an open side, and the passages of the left and right cooling blocks may be connected to the open passages of the longitudinal member.

The longitudinal member may be disposed under the cooling block, a partitioning unit may be formed to protrude on the top of the longitudinal member and may be assembled in the insertion groove, the passages of the longitudinal member may be formed on the left and right sides of the partitioning unit in a shape having an open top, and the passages of the left and right cooling blocks may be formed in a shape having an open bottom to be connected to the open passages of the longitudinal member.

The longitudinal member may be disposed on the top of the cooling block to be mounted between battery modules provided in the battery pack, and an insertion groove may be formed between the left and right cooling blocks so that the longitudinal member is inserted into the insertion groove while being supported by the left and right cooling blocks.

A member provided on the front side of the battery pack may be supported by the top surface of the longitudinal member.

Partitioning walls may be formed inside the cooling block in the left and right straight direction through extrusion molding.

As the coolant flowing into the left and right cooling blocks is discharged after independently cooling down only the battery module on the left or right side, the cooling path of the coolant is shortened, and thus the cooling path is simplified and optimized, and therefore, embodiments of the present invention have an effect of greatly improving cooling performance of the battery module through the technical solution described above.

Furthermore, as the load of the longitudinal member mounted on the battery module is supported by the left and right cooling blocks, structural robustness of the battery pack is secured, and as the load applied to the battery module is transferred to the cooling block through the module mounting unit and the longitudinal member, there is an advantage of effectively distributing the load.

### BRIEF DESCRIPTION OF THE DRAWINGS

FIG. 1 is a view showing a flowing direction of coolant in a battery pack according to embodiments of the present invention.

FIG. 2 is a view showing an inlet formed in a side member according to embodiments of the present invention.

FIG. 3 is a view showing the closed end of a first passage formed in a side member according to embodiments of the present invention.

FIG. 4 is a view showing an outlet formed in a longitudinal member according to embodiments of the present invention.

FIG. 5 is a view showing the shape of a battery system from which the battery module is removed according to embodiments of the present invention.

FIG. 6 is a view showing a structure in which the passage of the side member and the passage of the cooling block are connected to each other according to embodiments of the present invention.

FIG. 7 is a cross-sectional view taken along line A-A of FIG. 5, showing the configuration of a first embodiment, in which the passages of the cooling blocks and the passages of the longitudinal member are connected to each other.

FIG. 8 is a view showing the configuration of a second embodiment, in which the passages of the cooling blocks and the passages of the longitudinal member are connected to each other.

FIG. 9 is a view showing the configuration of a third embodiment, in which the passages of the cooling blocks and the passages of the longitudinal member are connected to each other.

FIG. 10 is a cross-sectional view taken along line B-B of FIG. 5, showing a structure in which the front member is supported on the longitudinal member.

### DETAILED DESCRIPTION OF ILLUSTRATIVE EMBODIMENTS

Hereinafter, the embodiments disclosed in this specification will be described in detail with reference to the accompanying drawings, and the same or similar components are given the same reference numerals, and duplicate description thereof will be omitted.

The suffixes “module” and “part” for the components used in the following description are assigned or interchangeably used only to facilitate preparation of the specification, and they do not have distinct meanings or roles distinguished from each other by themselves.

In describing the embodiments disclosed in this specification, when it is determined that the detailed descriptions of related known techniques may obscure the gist of the embodiments disclosed in this specification, the detailed description will be omitted. In addition, the accompanying drawings are only for easy understanding of the embodiments disclosed in this specification, and the technical spirit disclosed in this specification is not limited by the accompanying drawings and should be understood to include all changes, equivalents, and substitutes included in the spirit and technical scope of the present invention.

Although terms including ordinal numbers such as first, second, and the like may be used to describe various components, the components are not limited by the terms. The terms are used only for the purpose of distinguishing one component from another.

When a component is mentioned as being “connected” or “coupled” to another component, it should be understood that although the component may be directly connected or coupled to another component, other components may exist in the middle. On the contrary, when a component is mentioned as being “directly connected” or “directly coupled” to another component, it should be understood that no other component exists in the middle.

Singular expressions include plural expressions unless the context clearly dictates otherwise.

In this specification, terms such as “comprise”, “have”, and the like are intended to indicate the presence of a feature, a number, a step, an operation, a component, a part, or a combination thereof described in the specification, and it should be understood that the terms do not preclude the possibility of the presence or addition of one or more other features, numbers, steps, operations, components, parts, or combinations thereof.

Preferred embodiments of the present invention will be described below in detail with reference to the accompanying drawings.

A battery system for vehicles according to embodiments of the present invention is configured to include a cooling block 200 provided under a battery pack 100 and a cooling passage that forms a path through which coolant flows by connecting a passage in the cooling block 200 to passages in members disposed on the left and right sides of the battery pack 100 and a passage in a member disposed in the middle of the battery pack 100.

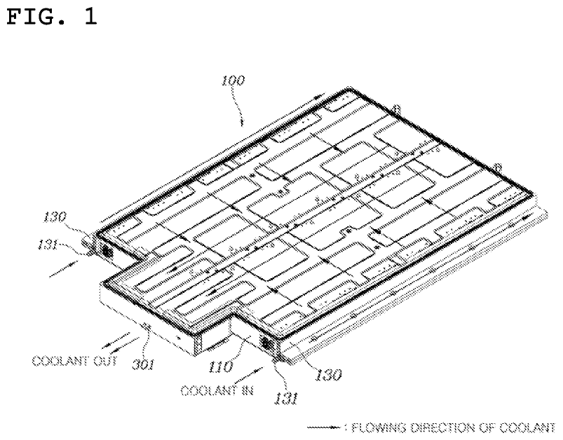

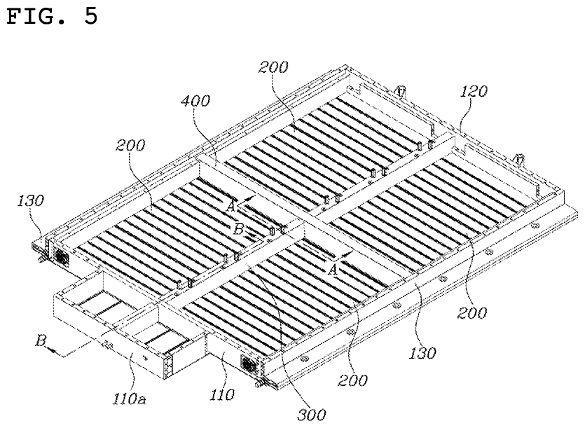

Referring to FIGS. 1 and 5, looking at the configuration of the battery pack 100 applied to embodiments of the present invention, a front member 110 and a rear member 120 are provided on the front and rear sides of the battery pack 100, and side members 130 are provided on the left and right sides of the battery pack 100.

As the front and rear ends of the side members 130 on the left and right sides are connected between the left and right ends of the front member 110 and the rear member 120, a rectangular space is formed.

In addition, a longitudinal member 300 is disposed between the center of the front member 110 and the center of the rear member 120, and a transverse member 400 is disposed between the center of the side member 130 on the left side and the center of the side member 130 on the right side to intersect with the longitudinal member 300.

Accordingly, as the longitudinal member 300 and the transverse member 400 are arranged to intersect with each other, the rectangular space is divided into a grid shape to secure four module areas, and a plurality of battery modules 500 is mounted in the module areas.

In addition, as a through-mounting that is mounted to penetrate from the upper case 140 to the lower case (symbol omitted) is configured at the intersection area of the transverse member 400 and the longitudinal member 300, the battery pack 100 is connected to the vehicle body through the through-mounting.

Since the through-mounting is provided only at the intersection area of the transverse member 400 and the longitudinal member 300, the space that can be occupied by the members and the through-mounting in the upper case 140 can be minimized.

Therefore, the weight/volume energy density can be maximized, and a maximum number of cells can be mounted within the same system space.

In addition, as the cells included in the battery module 500 are arranged in the transverse direction (left-right direction), the direction of surface pressure will be the longitudinal direction (front-rear direction).

Accordingly, as a module mounting member is provided inside the side members 130 on the left and right sides to mount the battery module 500, and an end plate bracket for surface pressure is provided inside the front member 110 and the rear member 120, surface pressure can be applied to the battery module 500.

Particularly, in embodiments of the present invention, the cooling block 200 is provided under the module area where the battery module 500 is mounted.

In addition, a cooling passage is formed so that coolant may flow into the cooling block 200 from the left and right of the cooling block 200, the coolant flowing into the cooling block 200 flows in the transverse direction toward the middle of the battery pack 100, and the coolant flowing toward the middle of the battery pack 100 flows in the longitudinal direction of the battery pack 100 to be discharged.

Accordingly, as shown in FIG. 1, the coolant flowing from the side member 130 on the left side of the longitudinal member 300 into the cooling block 200 on the left side cools down the battery module 500 on the left side, and the coolant flowing into the cooling block 200 on the right side from the side member 130 on the right side cools down the battery module 500 on the right side, and then the coolant is discharged in the longitudinal direction along the longitudinal member 300.

Accordingly, since the coolant flowing into the left or right cooling block 200 is discharged after independently cooling down only the left or right battery module 500, the cooling path of the coolant is shortened, and thus the cooling path is simplified and optimized, and therefore, cooling performance of the battery module 500 is improved greatly.

In addition, in embodiments of the present invention, the longitudinal member 300 is disposed in the longitudinal direction in the middle of the battery pack 100, a passage is formed along the longitudinal member 300, and the passage of the longitudinal member 300 is connected to the passage formed inside the cooling block 200, thus the coolant in the cooling block 200 may flow into the passage of the longitudinal member 300.

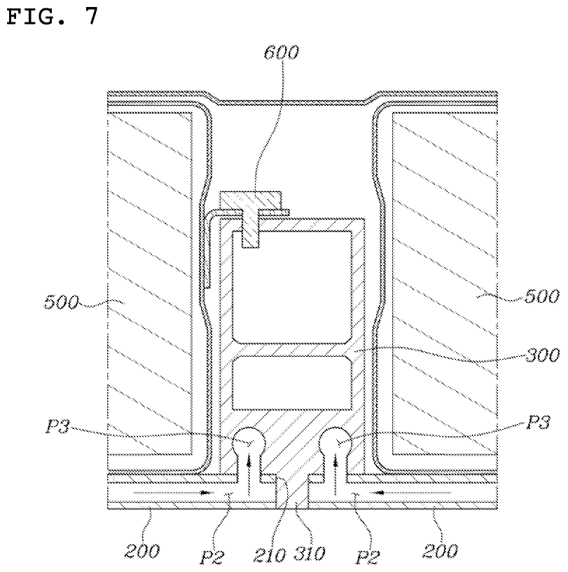

Referring to FIGS. 5 and 7, passages are formed on the left and right sides along the length direction inside the longitudinal member 300.

The coolant in the cooling block 200 on the left side flows into the left passage in the longitudinal member 300, and coolant in the cooling block 200 on the right side flows into the right passage in the longitudinal member 300, and then the coolant may be discharged through the left and right passages of the longitudinal member 300.

Meanwhile, the cooling passage of embodiments of the present invention is configured to include a first passage p1 formed in the longitudinal direction along the side members 130 provided on the left and right sides of the battery pack 100, a second passage p2 formed in the transverse direction inside the cooling block 200 to be connected to the first passage p1, and a third passage p3 formed in the longitudinal direction along the longitudinal member 300 provided in the middle of the battery pack 100 to be connected to the second passage p2.

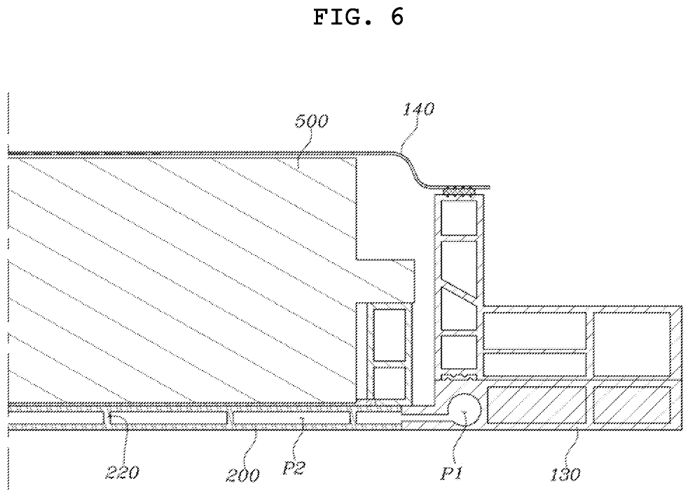

Describing with reference to FIGS. 6 and 7, the first passage p1 is formed along the front and rear straight direction of the side member 130 on the left side and the side member 130 on the right side.

In addition, as the second passage p2 is formed in the cooling block 200 in a shape having open left and right sides, and the open outer end of the second passage p2 is connected to the first passage p1, the first passage p1 and the second passage p2 communicate each other.

In addition, as the third passage p3 is formed along the front and rear straight direction of the longitudinal member 300, and the open inner end of the second passage p2 is connected to the third passage p3, the second passage p2 and the third passage p3 communicate each other.

That is, as a parallel structure in which the coolant flowing through the second passage p2 flows through several paths is formed between the first passage p1 and the third passage p3, cooling performance is further improved.

In addition, as shown in FIG. 7, in embodiments of the present invention, as the third passages p3 connected to the second passages p2 on the left and right sides are separately formed, the coolant may be independently discharged through each of the third passages p3.

That is, the third passages p3 are formed in the left and right sides inside the longitudinal member 300.

Accordingly, as the third passage p3 on the left side communicates with the second passage p2 formed in the left cooling block 200, and the third passage p3 on the right side communicates with the second passage p2 formed in the right cooling block 200, the coolant flows from the second passages p2 on the left and right sides into the third passages p3 on the left and right sides, and then is discharged from the third passages p3 on the left and right sides.

However, although not shown in the drawing, only one third passage p3 may be formed inside the longitudinal member 300, and in this case, the coolant in the second passage p2 of the left cooling block 200 and the coolant in the second passage p2 of the right cooling block 200 may merge and flow into the third passage p3 and then be discharged from the third passage p3.

In addition, in embodiments of the present invention, an inlet 131 through which coolant flows in may be provided at an end of the first passage p1, and an outlet 301 through which the coolant is discharged may be provided at an end of the third passage p3.

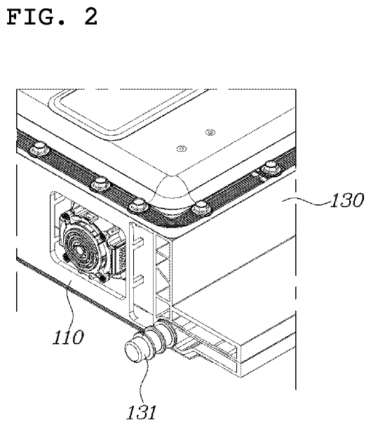

For example, as shown in FIG. 2, as inlets 131 connected to the first passages p1 are provided at the front ends of the side members 130 on the left and right sides, coolant flows into the first passage through the inlets 131.

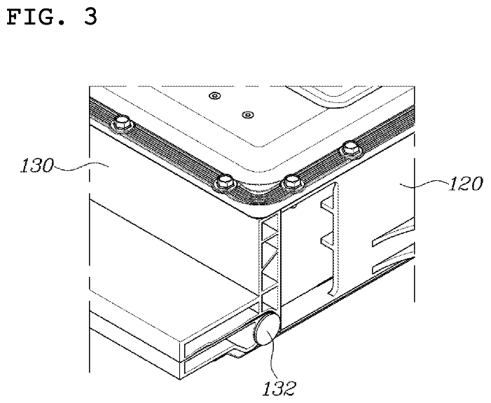

At this point, as shown in FIG. 3, as a stopper 132 is fixed at each of the rear ends of the side members 130 on the left and right sides, and the rear end of the first passage p1 is blocked, the coolant flowing into the first passage p1 through the inlet 131 may flow into the second passage p2.

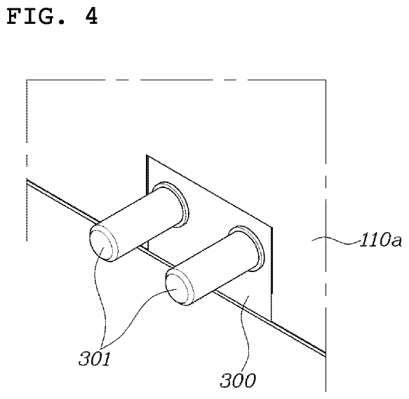

In addition, as shown in FIG. 4, as the outlet 301 connected to the third passage p3 is provided at the front end of the longitudinal member 300, the coolant in the third passage p3 is discharged through the outlet 301.

Meanwhile, embodiments of the present invention are configured such that an insertion groove 210 may be formed between the left and right cooling blocks 200, the longitudinal member 300 is assembled in the insertion groove 210, and the passages formed in the left and right cooling blocks 200 and the passages formed inside the longitudinal member 300 are open to each other while the longitudinal member 300 and the left and right cooling blocks 200 are in surface contact so that the passages of the cooling blocks 200 and the passages of the longitudinal member 300 may be connected to each other.

Referring to FIG. 7, the cooling block 200 and the longitudinal member 300 are connected by inserting the end portion of the longitudinal member 300 into the insertion groove 210 formed between the left cooling block 200 and the right cooling block 200 after connecting the side member 130 on the left side and the left cooling block 200 and connecting the side member 130 on the right side and the right cooling block 200.

Particularly, a surface-contact portion is generated between the cooling blocks 200 and the longitudinal member 300 as the longitudinal member 300 is assembled between the left and right cooling blocks 200, and as part of the surface-contact portion is formed open, the passages formed in the cooling blocks 200 and the passages formed inside the longitudinal member 300 communicate with each other.

That is, as the second passages p2 formed in the left and right cooling blocks 200 are formed open toward the left and right third passages p3 formed inside the longitudinal member 300, and the third passages p3 are formed open toward the second passages p2, the open portions are connected to each other, and the second passages p2 and the third passages p3 are formed to communicate with each other.

In addition, FIG. 7 is a view showing the configuration of a first embodiment, in which the passages of the cooling blocks 200 and the passages of the longitudinal member 300 are connected to each other.

Describing with reference to the drawing, a partitioning unit 310 is formed to protrude on the bottom of the longitudinal member 300 and is assembled in the insertion groove 210, passages of the longitudinal member 300 are formed on the left and right sides of the partitioning unit 310 in a shape having an open bottom, and the passages of the left and right cooling blocks 200 are formed in a shape having an open top to be connected to the open passages of the longitudinal member 300.

Specifically, as the partitioning unit 310 is formed at the bottom center of the longitudinal member 300 to protrude downward and is inserted into the insertion groove 210, the second passage p2 formed in the left cooling block 200 and the second passage p2 formed in the right cooling block 200 are physically partitioned by the partitioning unit 310.

In addition, as the top ends of the second passages p2 formed in the left and right cooling blocks 200 are formed open toward the left and right third passages p3 formed inside the longitudinal member 300, and the bottom ends of the third passages p3 are formed open toward the second passages p2, the open portions are connected to each other, and the second passages p2 and the third passages p3 are formed to communicate with each other.

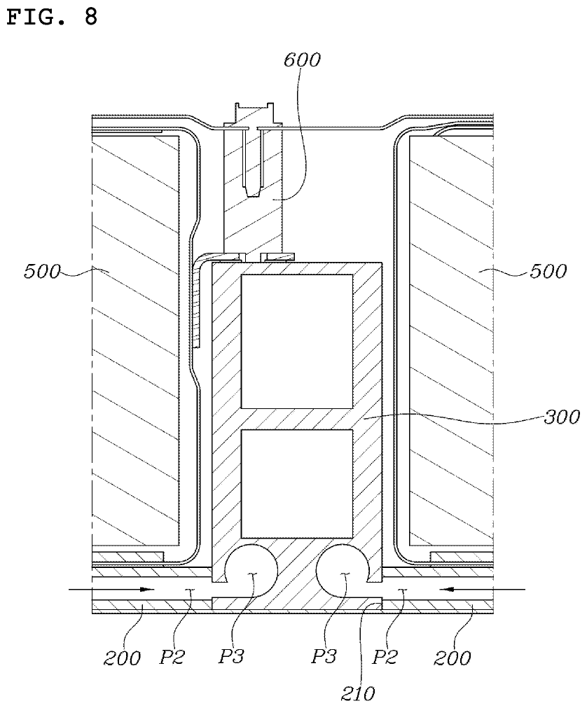

In addition, FIG. 8 is a view showing the configuration of a second embodiment, in which the passages of the cooling blocks 200 and the passages of the longitudinal member 300 are connected to each other.

Describing with reference to the drawing, the lower end of the longitudinal member 300 is assembled in the insertion groove 210, the passages of the longitudinal member 300 are formed in a shape having an open side, and the passages of the left and right cooling blocks 200 may be connected to the open passages of the longitudinal member 300.

Specifically, as the lower end of the longitudinal member 300 is inserted into the insertion groove 210, the second passage p2 formed in the left cooling block 200 and the second passage p2 formed in the right cooling block 200 are physically partitioned by the longitudinal member 300.

In addition, as the inner ends of the second passages p2 formed in the left and right cooling blocks 200 are open toward the left and right third passages p3 formed in the longitudinal member 300, and the outer ends of the left and right third passages p3 are formed open toward the left and right second passages p2, the open portions are connected to each other, and the second passages p2 and the third passages p3 are formed to communicate with each other.

In the case of the configuration of the second embodiment as described above, as the shape of the longitudinal member 300 is simplified, manufacturability of the longitudinal member 300 can be improved, and the connection structure may also be simplified.

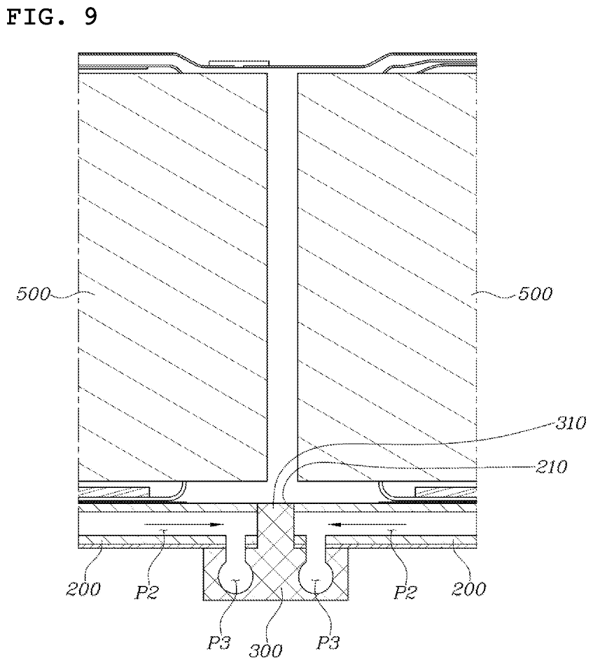

In addition, FIG. 9 is a view showing the configuration of a third embodiment, in which the passages of the cooling blocks 200 and the passages of the longitudinal member 300 are connected to each other.

Referring to the drawing, the longitudinal member 300 is disposed under the cooling block 200, a partitioning unit 310 is formed to protrude on the top of the longitudinal member 300 and is assembled in the insertion groove 210, passages of the longitudinal member 300 are formed on the left and right sides of the partitioning unit 310 in a shape having an open top, and the passages of the left and right cooling blocks 200 are formed in a shape having an open bottom to be connected to the open passages of the longitudinal member 300.

Specifically, as the partitioning unit 310 is formed at the top center of the longitudinal member 300 to protrude upward and is inserted into the insertion groove 210, the second passage p2 formed in the left cooling block 200 and the second passage p2 formed in the right cooling block 200 are physically partitioned by the partitioning unit 310.

In addition, as the bottom ends of the second passages p2 formed in the left and right cooling blocks 200 are formed open toward the left and right third passages p3 formed inside the longitudinal member 300, and the top ends of the third passages p3 are formed open toward the second passages p2, the open portions are connected to each other, and the second passages p2 and the third passages p3 are formed to communicate with each other.

In the case of the configuration of a third embodiment as described above, it can be applied in a structure where the longitudinal member 300 is difficult to be disposed inside a case, such as a Cell to Pack (CTP) battery, and as the longitudinal member 300 is disposed under the cooling block 200, the ability of mounting the battery module 500 inside a case can be improved.

Meanwhile, in embodiments of the present invention, the longitudinal member 300 may be disposed on the top of the cooling block 200 to be mounted between the battery modules 500 provided in the battery pack 100, and an insertion groove 210 is formed between the left and right cooling blocks 200 so that the longitudinal member 300 may be inserted into the insertion groove 210 while being supported by the left and right cooling blocks 200.

Describing with reference to FIG. 7, the top of the longitudinal member 300 and the battery module 500 are mounted by a module mounting unit 600. The top of the module mounting unit 600 may also be fastened to the upper case 140.

Accordingly, structural robustness of the battery pack 100 is secured by constructing a structure in which passages are formed between the left and right cooling blocks 200 and the longitudinal member 300 and, in particular, the load of the longitudinal member 300 mounted between the battery modules 500 is supported by the left and right cooling blocks 200.

Moreover, as the battery module 500, the module mounting unit 600, the longitudinal member 300, and the cooling block 200 are mechanically connected, a load transfer path connected from the battery module 500 to the cooling block 200 is formed.

Therefore, as most of the load such as vibration/shock applied to the battery module 500 is transferred to the longitudinal member 300 through the module mounting unit 600, and the load transferred to the longitudinal member 300 is transferred to the cooling block 200, the load is effectively distributed through the cooling block 200.

In addition, in embodiments of the present invention, the member provided on the front side of the battery pack 100 may be supported by the top surface of the longitudinal member 300.

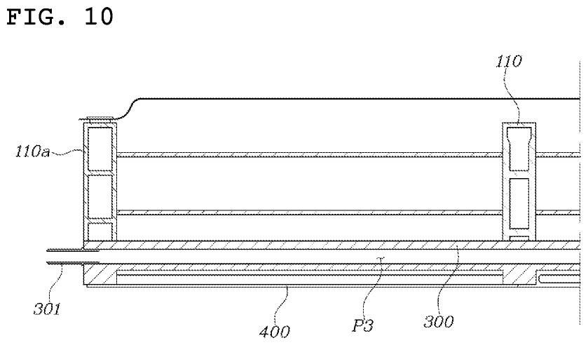

Describing with reference to FIG. 10, a front member 110 may be disposed on the front side of the battery pack 100 to provide a rectangular space in which the battery module 500 is mounted, and a foremost-front member 110a may be further disposed in front of the front member 110.

In addition, as the longitudinal member 300 continues to the front end of the battery pack 100, the front member 110 and the foremost-front member 110a are supported by the top surface of the longitudinal member 300 while intersecting the longitudinal member 300.

Therefore, a load transfer path is implemented in the front/rear direction, and a structure robust to compression and collision of the battery is secured.

Meanwhile, in embodiments of the present invention, partitioning walls 220 may be formed inside the cooling block 200 in the left and right straight direction through extrusion molding.

Referring to FIG. 6, the coolant flowing in the longitudinal direction along the first passage p1 formed in the side member 130 flows in the transverse direction through the second passage p2 formed inside the cooling block 200 in the left and right straight direction by extrusion molding.

Particularly, structural rigidity of the battery pack 100 is secured through the structure of the extruded-material partitioning wall 220 of the cooling block 200 that supports the battery module 500, and a structure robust to collision in the event of compression/collision from the side is secured by implementing the load transfer path.

Accordingly, as embodiments of the present invention effectively reduce the phenomenon of generating resonance and local fatigue durability of the upper case 140 even when vibration is transferred to the battery pack 100, generation of noise and the risk of damage to the components from generation of resonance of the upper case 140 can be prevented, and collision/durability/NVH rigidity between the vehicle and the battery are secured.

Meanwhile, although embodiments of the present invention have been described in detail only with respect to the specific examples described above, it is clear to those skilled in the art that various modifications and changes are possible within the technical scope of the present invention, and it is natural that such modifications and changes fall within the scope of the appended patent claims.

What is claimed is:

1. A battery system comprising:
a cooling block disposed under a battery pack; and
a cooling passage that defines a path through which coolant flows by connecting a first passage in the cooling block to second passages in first members disposed on left and right sides of the battery pack and a third passage in a second member disposed at a middle of the battery pack.

2. The battery system according to claim 1, wherein:
the second member comprises a longitudinal member disposed in a longitudinal direction at the middle of the battery pack;
the third passage is disposed along the longitudinal member in the longitudinal direction; and
the third passage is connected to the first passage in the cooling block such that the coolant in the cooling block flows into the third passage.

3. The battery system according to claim 2, wherein:
the cooling block comprises a left cooling block and a right cooling block, each of the left cooling block and the right cooling block comprising the first passage;
an insertion groove is disposed between the left cooling block and the right cooling block;
the longitudinal member is assembled in the insertion groove; and
the first passage disposed in each of the left cooling block and the right cooling block and the third passage disposed along the longitudinal member are open to each other while the longitudinal member, the left cooling block, and the right cooling block are in surface contact so that each of the first passages and the third passage are connected to each other.

4. The battery system according to claim 3, further comprising a partitioning unit disposed to protrude on a bottom of the longitudinal member and assembled in the insertion groove.

5. The battery system according to claim 4, wherein:
the third passage of the longitudinal member is disposed on each of a left side and a right side of the partitioning unit in a shape having an open bottom; and
the first passage of each of the left cooling block and the right cooling block have a shape having an open top to be connected to the third passages of the longitudinal member having the open bottom.

6. The battery system according to claim 3, wherein:
a lower end of the longitudinal member is assembled in the insertion groove;
the third passage of the longitudinal member has a shape having an open side; and
the first passage of each of the left cooling block and the right cooling block are connected to the open side of the third passage of the longitudinal member.

7. The battery system according to claim 3, wherein:
the longitudinal member is disposed under the cooling block;
a partitioning unit protrudes on a top of the longitudinal member and is assembled in the insertion groove;
the third passage of the longitudinal member is disposed on each of a left side and a right side of the partitioning unit in a shape having an open top; and
the first passage of each of the left cooling block and the right cooling block have a shape having an open bottom to be connected to the open top of the third passage.

8. The battery system according to claim 2, wherein:
the cooling block comprises a left cooling block and a right cooling block, each of the left cooling block and the right cooling block comprising the first passage;
the longitudinal member is disposed on a top of the cooling block to be mounted between battery modules disposed in the battery pack; and
an insertion groove is disposed between the left cooling block and the right cooling block so that the longitudinal member is inserted into the insertion groove while being supported by the left cooling block and the right cooling block.

9. The battery system according to claim 8, further comprising a third member disposed at a front side of the battery pack and supported by a top surface of the longitudinal member.

10. The battery system according to claim 2, further comprising partitioning walls disposed inside the cooling block in a left and right straight direction through extrusion molding.

11. A battery system comprising:
a cooling block disposed under a battery pack; and
a cooling passage that defines a path through which coolant flows, the cooling passage comprising:
first passages disposed in a longitudinal direction along side members disposed on a left side and a right side of the battery pack;
a second passage disposed in a transverse direction inside the cooling block to be connected to the first passage; and
third passages disposed in the longitudinal direction along a longitudinal member disposed at a middle of the battery pack to be connected to the second passage.

12. The battery system according to claim 11, wherein the third passages are unconnected, and wherein the third passages are connected respectively to the first passages on the left side and the right side of the battery pack such that the coolant is independently discharged through each of the third passages.

13. The battery system according to claim 11, further comprising:
inlets disposed at a first end of each of the first passages, respectively, wherein the inlets are configured to allow the coolant to flow into the first passages; and
outlets disposed at a first end of each of the third passages, respectively, wherein the outlets are configured to discharge the coolant.

14. The battery system according to claim 11, wherein:
the cooling block comprises a left cooling block and a right cooling block, each of the left cooling block and the right cooling block comprising the second passage; and
an insertion groove is disposed between the left cooling block and the right cooling block.

15. The battery system according to claim 14, wherein:
the longitudinal member is assembled in the insertion groove; and
the second passages disposed in each of the left cooling block and the right cooling block are open to a respective one of the third passages, while the longitudinal member, the left cooling block, and the right cooling block are in surface contact so that each of the second passages is connected to each of the third passages, respectively.

16. A vehicle comprising:
a vehicle body;
a battery pack comprising a front member at a front side of the battery pack, a rear member at a rear side of the battery pack, a left side member at a left side of the battery pack and connecting a left side of the front member and a left side of the rear member to each other, a right side member at a right side of the battery pack and connecting a right side of the front member and a right side of the rear member to each other, a longitudinal member extending in a longitudinal direction from a center of the front member to a center of the rear member, and a transverse member extending in a transverse direction from a center of the left side member to a center of the right side member;
a through-mounting disposed at an intersection area of the transverse member and the longitudinal member, wherein the through-mounting connects the battery pack to the vehicle body;
a cooling block disposed under the battery pack; and
a cooling passage that defines a path through which coolant flows, wherein the cooling passage comprises a first passage in the cooling block, a second passage in each of the left side member and the right side member, and a third passage in the longitudinal member.

17. The vehicle according to claim 16, wherein:
the cooling block comprises a left cooling block and a right cooling block;
the first passage is included in each of the left cooling block and the right cooling block;
an insertion groove is disposed between the left cooling block and the right cooling block; and
the longitudinal member is assembled in the insertion groove.

18. The vehicle according to claim 17, wherein the first passage in each of the left cooling block and the right cooling block and the third passage in the longitudinal member are open to each other while the longitudinal member, the left cooling block, and the right cooling block are in surface contact so that each of the first passages and the third passage are connected to each other.

19. The vehicle according to claim 17, further comprising a partitioning unit disposed to protrude on a bottom of the longitudinal member and assembled in the insertion groove, wherein the partitioning unit divides the third passage in the longitudinal direction.

20. The vehicle according to claim 18, wherein:
a lower end of the longitudinal member is assembled in the insertion groove;
the third passage of the longitudinal member has a shape having an open side; and
the first passage of each of the left cooling block and the right cooling block are connected to the open side of the third passage of the longitudinal member.
